(19) United States
(12) Patent Application Publication
(10) Pub. No.: US 2021/0285381 A1
(43) Pub. Date: Sep. 16, 2021

(54) SYSTEM AND METHOD FOR ENGINE PRE-SHUTDOWN MOTORING

(71) Applicant: PRATT & WHINEY CANADA CORP., Longueuil (CA)

(72) Inventor: Dana TOMESCU, Brampton, CA (US)

(21) Appl. No.: 16/818,995

(22) Filed: Mar. 13, 2020

(51) Int. Cl. F02C 9/00

(52) U.S. Cl. CPC F02C 9/00; F05D 2270/05; F05D 2220/323

(57) ABSTRACT

A method and a system for pre-shutdown motoring of an aircraft engine are provided. A period of time during which the engine, prior to a shutdown thereof, was operating at a power level below a predetermined threshold is tracked. Based on the tracked period of time, a motoring duration for the engine is determined. The engine is then ran, prior to the shutdown thereof, at a low power setting for the motoring duration.

### TECHNICAL FIELD

The application relates generally to gas turbine engines and, more particularly, motoring of a gas turbine engine.

### BACKGROUND OF THE ART

Following shutdown of a gas turbine engine, residual heat is trapped in the engine core. As the temperature of the engine decreases towards ambient temperature, a thermal gradient develops in the engine leading to the upper portion of the engine cooling more slowly than the lower portion. This results in distortion (or bowing) of the engine components due to thermal expansion (or contraction). Damage can be caused to the engine if the engine rotors are spooled up while in a bowed state and it is undesirable to restart the engine until the engine cools and rotor bow dissipates to an acceptable level. Moreover, when fuel supply to the engine is turned off following engine shutdown, stagnant fuel may be present in the fueling system. If the residual fuel is heated beyond a predetermined temperature, coke particulates can build up, which can in turn reduce the effectiveness of the fueling system or completely block fuel flow. Coking may also occur in the engine's oil system due to high temperatures.

As such, there is need for improvement.

### SUMMARY

In one aspect, there is provided a method for pre-shutdown motoring of an aircraft engine, the method comprising, at a processing device, tracking a period of time during which the engine, prior to a shutdown thereof, was operating at a power level below a predetermined threshold, determining, based on the tracked period of time, a motoring duration for the engine, and running the engine, prior to the shutdown thereof, at a low power setting for the motoring duration.

In another aspect, there is provided a system for pre-shutdown motoring of an aircraft engine, the system comprising at least one processing unit and a non-transitory memory communicatively coupled to the at least one processing unit and comprising computer-readable program instructions executable by the at least one processing unit for tracking a period of time during which the engine, prior to a shutdown thereof, was operating at a power level below a predetermined threshold, determining, based on the tracked period of time, a motoring duration for the engine, and running the engine, prior to the shutdown thereof, at a low power setting for the motoring duration

In a further aspect, there is provided a non-transitory computer readable medium having stored thereon program code executable by at least one processor for tracking a period of time during which an aircraft engine, prior to a shutdown thereof, was operating at a power level below a predetermined threshold, determining, based on the tracked period of time, a motoring duration for the engine, and running the engine, prior to the shutdown thereof, at a low power setting for the motoring duration.

### DESCRIPTION OF THE DRAWINGS

Reference is now made to the accompanying figures in which:

FIG. 1A is a schematic cross-sectional view of a gas turbine engine;

FIG. 1B is a block diagram of a system for pre-shutdown motoring, in accordance with an illustrative embodiment;

FIG. 2 is a block diagram of a computing device for implementing the control unit of FIG. 1B, in accordance with an illustrative embodiment;

FIG. 3 is a flowchart of a method for pre-shutdown motoring, in accordance with an illustrative embodiment; and

FIG. 4 is a flowchart of the step of FIG. 3 of performing a pre-shutdown motoring procedure.

### DETAILED DESCRIPTION

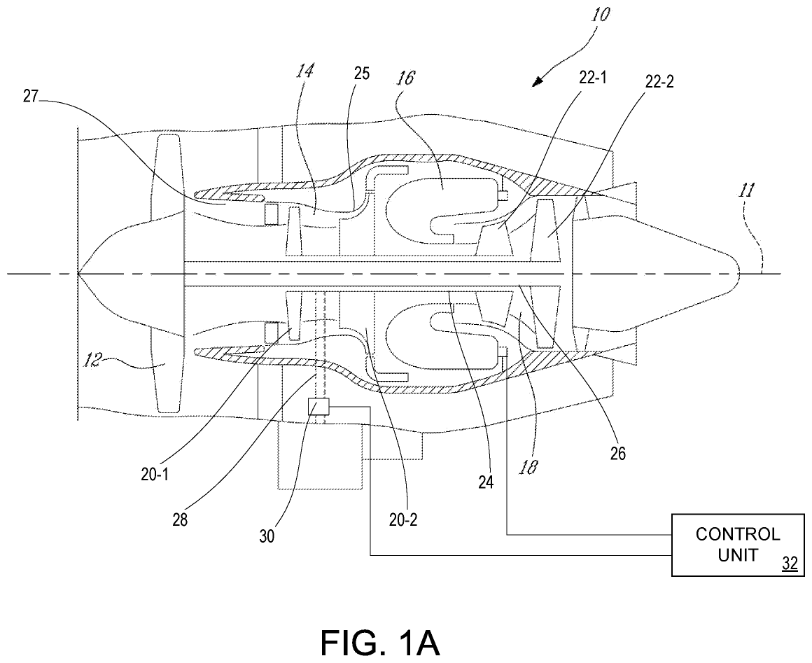

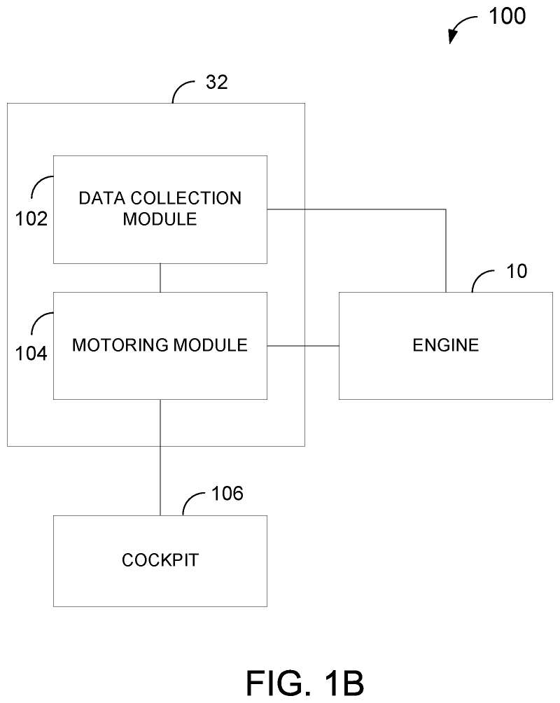

FIG. 1A illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

Compressor section 14 includes compressors 20, namely, a low-pressure compressor 20-1 and a high-pressure compressor 20-2. Turbine section 18 includes turbines 22, namely, a high-pressure turbine 22-1 and a low-pressure turbine 22-2.

Fan 12, compressors 20 and turbines 22 are mounted to shafts 24, 26 for rotation about a longitudinal axis 11. Low-pressure compressor 20-1, high-pressure compressor 20-2 and high-pressure turbine are mounted to a common first shaft 24, and may be collectively referred to as a high-speed spool or high-speed rotor assembly. Fan 12 and low-pressure turbine 22-2 are mounted to a common second shaft 26 and may be collectively referred to as a low-speed spool or low-speed rotor assembly. During operation, compressors 20 and combustor 16 provide a stream of high-temperature and high-pressure gas to turbines 22, causing turbines 22 to rotate. Rotation of turbines 22 drives rotation of compressors 20 and fan 12 by way of shafts 24, 26.

Engine 10 has an air starter 28 for inducing direct rotation of the high-speed and indirect rotation of the low-speed rotor assemblies at engine start-up. Air starter 28 is provided with a supply of pressurized air from an independent unit. Flow of air to starter 28 is modulated by a starter valve (also referred to as a starter air valve) 30.

Starter valve 30 is solenoid-actuated and operated (e.g. engaged) by a signal from a control unit 32. Control unit 32 is further in communication with a plurality of control elements and sensors (not shown), such as a throttle, speed and temperature sensors, and the like. Control unit 32 is also in communication with one or more aircraft systems (not shown), which may include, but are not limited to, flight controls, electric systems, auxiliary power units, and the like, as well as with aircraft avionics (not shown), which may include any and all systems related to control and management of the aircraft, such as but not limited to communications, navigation, display, monitoring, flight-control systems, collision-avoidance systems, flight recorders, weather systems, and aircraft management system. The control unit 32 is also in communication with the cockpit of the aircraft (reference 106 in FIG. 1B).

While the engine 10 is illustrated and described herein as using a starter valve 30 and an air starter 28 for inducing rotation of the engine 10, it should be understood that other embodiments may apply. The systems and methods described herein may apply to engines as in 10 that use any suitable means of providing rotational power to the engine, including, but not limited to, an air turbine starter, a starter air valve, a pneumatic starter motor, a starter generator, and an electric motor.

In addition, while the engine 10 is illustrated and described herein as being a turbofan engine, it should be understood that this is for illustration purposes only. The systems and methods described herein may apply to any suitable type of engine including, but not limited to, a turbofan engine, a geared turbofan engine, a turboprop engine, a turboshaft engine, an auxiliary power unit, an electric engine, and a hybrid electric propulsion system.

Referring back to FIG. 1A, during operation of engine 10, pressurization of air by compressors 20 and fuel combustion in combustor 16 produce high temperatures, particularly in the combustor 16 and turbine section 18. Temperatures may depend on the operating state of engine 10, among other conditions. For example, high-thrust operation, such as high-speed cruising, may rely on high rates of fuel combustion, which may produce relatively high temperatures in turbine 18. Conversely, other operating states may require less thrust and thus may entail combustion of lower quantities of fuel. For example, while taxiing, (e.g. on a runway), fuel is combusted at a much lower rate, and less heat is introduced to engine 10.

High temperatures within engine 10 may persist for a period of time after engine shutdown. For example, airflow through engine 10 substantially ceases after engine 10 is shut down and air tends to stagnate within the core of engine 10. Thus, heat dissipates relatively slowly from the high operating temperatures of components.

While engine 10 is shut down, temperature distribution within the engine 10 may be asymmetrical. For example, relatively cool and dense air may settle toward the bottom of the engine 10. Conversely, hotter and less dense air may rise toward the top of the engine 10, resulting in a temperature profile that generally increases from bottom to top. In other words, components near the top of engine 10 may tend to remain hotter than components near the bottom of engine 10.

As noted, components of engine 10 may experience thermal expansion when subjected to elevated temperatures. Following engine shutdown, thermal contraction may be non-uniform, due to temperature profiles within engine 10. As the temperature of a given rotor decreases towards ambient temperature, a thermal gradient develops in the rotor leading to an upper portion of the rotor cooling more slowly than a lower portion of the rotor. This results in distortion (or bowing) within the engine, which prevents the use of the aircraft for a certain period of time (referred to as a ‘lock-out time’) until the engine 10 has cooled down. Bowing of the engine case may also occur, resulting in a reduction in normal build clearances and leading to potential rubbing between the engine's rotating turbomachinery and the closed-down case structure of the engine 10. The rub condition can in turn cause a hung start or performance loss for the engine 10. In addition, when stagnant fuel remaining in the engine's fuel system is exposed to high temperatures, coke particulates can begin to build up in the fuel, at the tip and/or on the walls of nozzles of the engine's fuel system and/or in the fuel system's manifold, reducing the nozzles' effectiveness, or completely blocking fuel from passing through the nozzles. This phenomenon is referred to as ‘fuel coking’. Coke particulates may also build up in the engine's oil system, a phenomenon referred to as ‘oil coking’.

Airport ground temperature usually affects engine cooling time, such that it may take longer until the required operational temperature of the engine 10 is achieved. It is proposed herein to reduce the engine's lock-out time by performing a motoring procedure before engine shutdown. FIG. 1B illustrates an example system 100 for pre-shutdown motoring of the engine 10 of FIG. 1A. The system 100 comprises the control unit 32, which controls operation of the engine 10, and particularly operation (e.g., opening and closing) of the starter valve (reference 30 in FIG. 1A) that modulates the flow of air to the starter (reference 28 in FIG. 1A) and induces rotation of the engine's rotor assemblies. In one embodiment, the control unit 32 is an Electronic Engine Controller (EEC).

As will be discussed further below, the illustrated system 100 performs a pre-shutdown motoring procedure which involves running the engine 10 at a low power setting for a prescribed duration, prior to a shutdown of the engine 10. In this manner, cooling air may be provided for reducing the temperature of the engine 10. In one embodiment, the cooling air may be provided upon the engine 10 executing the pre-shutdown motoring procedure) to alleviate the thermal gradient in the rotor, thereby mitigating (i.e. reducing) rotor distortion (or bowing). Thus, the pre-shutdown motoring procedure performed by the system 100 may protect the engine 10 from spooling up with a rotor that has been deformed (or bowed) due to asymmetric thermal expansion (or contraction). In another embodiment, the cooling air may be provided to prevent exposure of stagnant fuel to high temperatures and accordingly prevent (or reduce) the accumulation of coke particulates within the engine's fuel system, thereby impeding (or reducing) fuel coking.

In one embodiment, the control unit 32 comprises a data collection module 102 and a motoring module 104. The illustrated data collection module 102 is configured to collect and store (referred to herein as ‘tracking’) the amount of time spent by the engine 10 at a low power setting, prior to engine shutdown. As used herein, the term ‘low power setting’ refers to an operational setting (including, but not limited to, ground idle and taxiing) in which the engine 10 is operating at a power level below a predetermined threshold.

In one embodiment, the data collection module 32 may comprise a timer used to track the amount of time spent by the engine 10 at the low power setting. The timer may be started when the speed of the engine 10 is below a predetermined speed threshold for a certain period of time. In another embodiment, the timer may be started when the engine 10 has reached a specific speed profile and an associated time. The timer may be reset at any suitable point in time. In one embodiment, the timer may be reset if the speed of the engine 10 exceeds an upper limit (e.g., 3000 revolutions per minute (RPM)) for a given amount of time. Other embodiments may apply. It should be understood that other suitable means of tracking the amount of time spent by the engine 10 at the low power setting may be used. For example, in one embodiment, timestamps may be used.

The motoring module 104 illustratively uses the collected data to prescribe an appropriate motoring cycle (or procedure), e.g. determine the duration (referred to herein as a ‘motoring duration’) required to complete the motoring procedure. Indeed, the more time spent by the engine 10 at a low power setting (e.g. while taxiing or idling) prior to shutdown, the less motoring time is required to alleviate rotor distortion and/or impede fuel coking. In other words, the higher the amount of time spent by the engine 10 within a given low power range (i.e. at the low power setting) prior to the engine 10 being shut down, the lower the motoring duration prescribed by the motoring module 104. Thus, by tracking (at the data collection module 102) the time spent by the engine 10 at the low power setting prior to engine shutdown, the system 100 can optimize the motoring duration for a given motoring procedure.

In one embodiment, using the data received from the data collection module 102, the motoring module 104 first assesses whether pre-shut down motoring of the engine 10 is to be performed and for how long (i.e. for which motoring duration). This may be achieved by querying a lookup table (or other suitable data structure), which provides a value for the motoring duration as a function of the time spent at the low power setting, and correlating the amount of time spent by the engine 10 at the low power setting (as tracked by the data collection module 102) with the data from the lookup table. The lookup table may be pre-calculated and stored in memory for subsequent access. In one embodiment, the lookup table is determined via engine testing and analysis to determine the motoring time required to alleviate rotor distortion (or bowing) and/or impede fuel coking. In other words, the motoring module 104 illustratively determines from the lookup table the appropriate motoring procedure to be executed by the engine 10 for mitigating rotor bowing and/or preventing fuel coking.

Upon querying the lookup table, the motoring module 104 may determine that the pre-shutdown motoring procedure is not required because the amount of time spent by the engine 10 at the low power setting (referred to as a ‘sufficient’ amount of time) is above a predetermined threshold. In this case, the motoring module 104 may set the motoring duration to zero based on the lookup table value(s), which would result in no motoring being performed. Alternatively, the motoring module 104 may determine that the amount of time spent by the engine 10 at the low power setting is below the threshold (referred to herein as an ‘insufficient’ amount of time) and that pre-shutdown motoring is accordingly required. The motoring module 104 may then obtain, from the lookup table, the motoring duration suitable for the pre-shutdown motoring procedure to be performed, as a function of the time spent by the engine 10 at the low power setting prior to shutdown.

It should be understood that the motoring duration may vary, depending on a number of factors including, but not limited to, engine configuration (e.g., engine materials and respective coefficients of thermal expansion, cooling rates, and the like). The motoring duration (and accordingly whether the engine 10 has spent a sufficient or insufficient amount of time at the low power setting) may be determined through testing/analysis and may differ from one engine model to another. It should also be understood that, while reference is made herein to lookup table(s) being used to determine the motoring duration suitable for the pre-shutdown motoring procedure, the motoring module 104 could instead cause a standard motoring to be performed for a specific amount of time (e.g., 4 minutes), without using lookup table(s).

The motoring module 104 may also obtain, from the lookup table, the rotational speed (referred to herein as the ‘motoring speed’) at which to run the engine 10 during the pre-shutdown motoring procedure. The lookup table may indeed provide a value for the motoring speed as a function of the motoring duration and the time spent at the low power setting. In one embodiment, the motoring procedure may indeed involve running the engine at a pre-determined constant speed for the motoring duration, prior to shutdown. In another embodiment, the motoring procedure may involve running the engine at a decreasing speed (up to a pre-determined level) for the motoring duration, in order to bring the engine 10 to a gradual stop. In yet another embodiment, the motoring procedure may involve running the engine at a discontinuous (or intermittent) speed of rotation, where the rotational speed of the engine 10 is increased and decreased (to pre-determined levels) for the motoring duration (or a motoring interval associated with the motoring procedure is optionally varied), prior to shutdown. As used herein, the term ‘motoring interval’ may therefore in one embodiment refer to the period of time (or frequency) between the application of rotational speed that defines the engine's revolutions per minute. In another embodiment, the term ‘motoring interval’ may refer to the device that provides rotational power to the engine 10. For instance, the motoring interval may refer to the open and closing interval of the starter valve (reference 30 in FIG. 1A) or to the commanded on/off power from an electric motor that provides rotational power to the engine 10.

Once the motoring duration and the motoring speed have been determined, the motoring module 104 may, upon receipt of a commanded engine shutdown, send one or more signals to the engine 10 to cause the motoring procedure to be automatically initiated (i.e. cause the engine 10 to run at a given motoring speed for the motoring duration as determined). Alternatively, the motoring module 104 may send a message (i.e. a motoring command) to the cockpit 106 (via any suitable cockpit interface) to command motoring, the message comprising an indication of the motoring duration (and optionally the motoring speed) as determined. If the motoring module 104 receives (using any interface in the cockpit, for example discrete inputs from a button press or a long hold for added protection against inadvertent selection) an indication that the pilot has rejected the motoring command, the motoring module 104 may then abort the motoring procedure. Otherwise, if the motoring module 104 receives an indication that the pilot has accepted the motoring command, the motoring module 104 may then cause the engine 10 to run (i.e. execute) the motoring procedure (at a constant, intermittent, or decreasing speed, as discussed above) for a prescribed motoring duration, prior to engine shutdown.

In one embodiment, the prescribed duration is the motoring duration determined by the motoring module 104. In another embodiment, the motoring module 104 may receive, along with an indication that the pilot has accepted the motoring command, a partial motoring duration to be prescribed (e.g., as determined by the pilot), the partial motoring duration being lower than the motoring duration determined by the motoring module 104. In this case, the motoring module 104 may then cause the engine 10 to run the motoring procedure for the partial duration, prior to engine shutdown. The motoring module 104 may then constantly monitor the status of the engine 10 in order to determine whether the motoring procedure has been completed (e.g., whether the prescribed duration has elapsed). Once this is the case, the motoring module 104 may then send a corresponding message to the cockpit 106 (via the cockpit interface).

In one embodiment, the motoring procedure may be aborted by the pilot at any time. For example, the motoring procedure may be aborted by commanding an engine shutdown, e.g. following a pilot-initiated or an EEC-initiated motoring abort command. The motoring procedure may also be aborted when the control unit 32 detects a failure or exceedance of one or more engine rotation speed sensors (e.g. an N1 sensor, with N1 being the engine's fan speed). For instance, the motoring procedure may be aborted by commanding an engine shutdown when N1 is less than a first speed threshold for a given time period (e.g. 20 seconds), N1 is less than the first threshold for a given time interval (e.g. 2 seconds) after N1 has transitioned above the first threshold, N1 has exceeded a second speed threshold, or there is no valid engine rotation speed sensor signal (e.g. N1 signal) after a given time interval (e.g. 10 seconds) has elapsed since the starter valve (reference 30 in FIG. 1A) has been commanded open. In one embodiment, the first threshold corresponds to a low speed abort threshold, where the motoring procedure is aborted in the event the engine 10 does not perform as expected (e.g. is not able to govern). In one embodiment, the second speed threshold is a threshold set to protect the rotor from approaching a resonant speed. It should also be understood that the motoring procedure may also be aborted if other component failure indications or emergency situations, such as fire, occur during the motoring procedure.

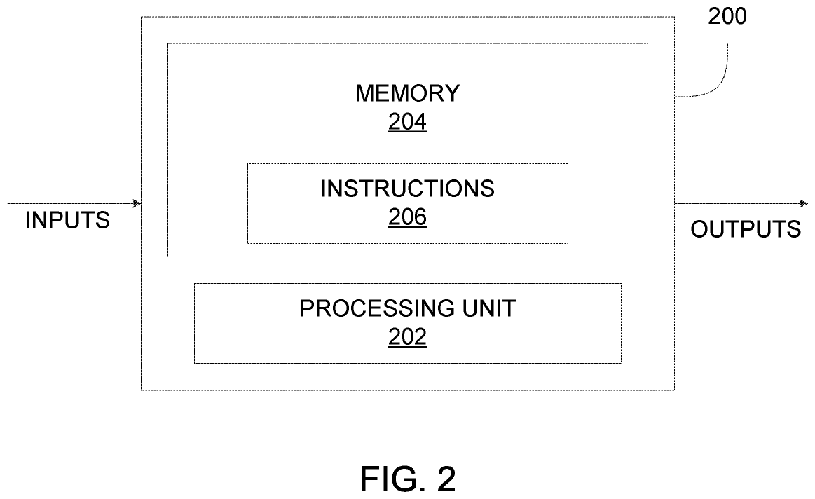

FIG. 2 is an example embodiment of a computing device 200 for implementing the control unit 32 described above with reference to FIG. 1B. The computing device 200 comprises a processing unit 202 and a memory 204 which has stored therein computer-executable instructions 206. The processing unit 202 may comprise any suitable devices configured to cause a series of steps to be performed such that instructions 206, when executed by the computing device 200 or other programmable apparatus, may cause the functions/acts/steps described herein to be executed. In one embodiment, the processing unit 202 has the ability to interpret discrete inputs and energize discrete outputs. The processing unit 202 may comprise, for example, any type of general-purpose microprocessor or microcontroller, a digital signal processing (DSP) processor, a CPU, an integrated circuit, a field programmable gate array (FPGA), a reconfigurable processor, other suitably programmed or programmable logic circuits, or any combination thereof.

The memory 204 may comprise any suitable known or other machine-readable storage medium. The memory 204 may comprise non-transitory computer readable storage medium, for example, but not limited to, an electronic, magnetic, optical, electromagnetic, infrared, or semiconductor system, apparatus, or device, or any suitable combination of the foregoing. The memory 204 may include a suitable combination of any type of computer memory that is located either internally or externally to device, for example random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like. Memory 204 may comprise any storage means (e.g., devices) suitable for retrievably storing machine-readable instructions 206 executable by processing unit 202.

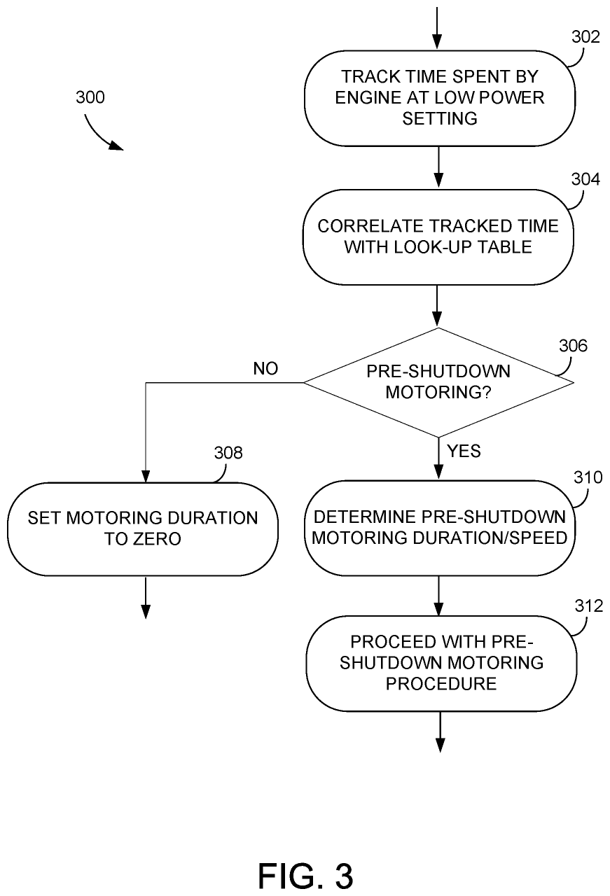

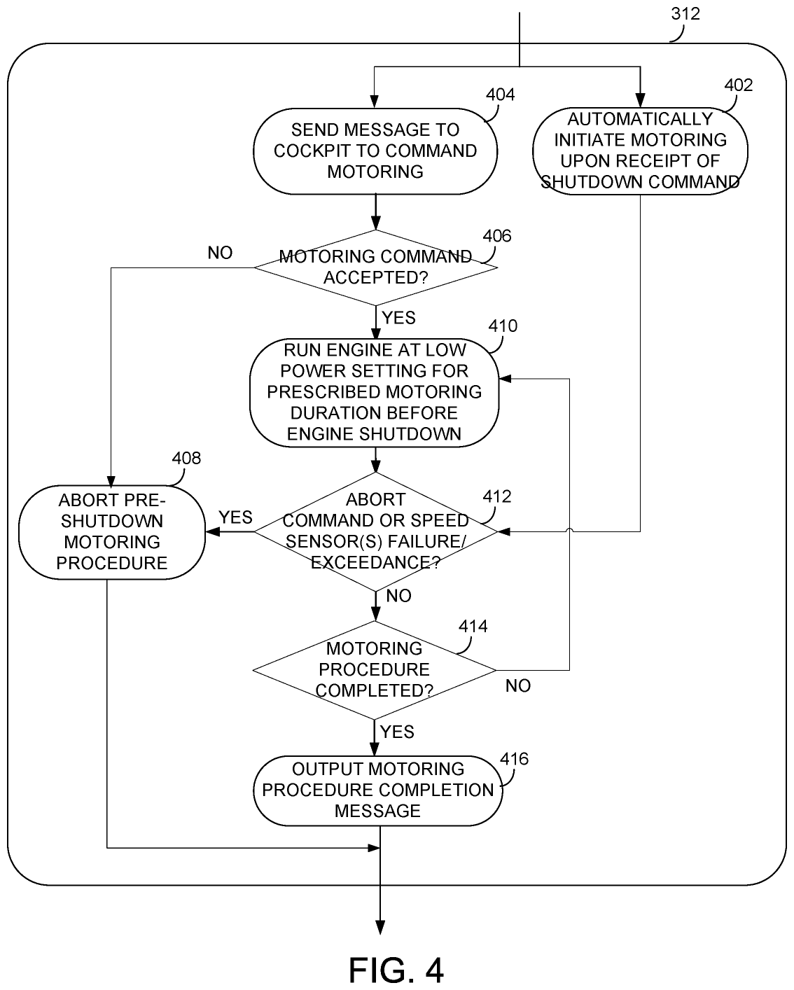

Referring now to FIG. 3 and FIG. 4, an example method 300 for pre-shutdown motoring will now be described. The method 300 may be implemented by the computing device 200 of FIG. 2. The method 300 comprises tracking, in the manner described above with reference to FIG. 1B, the time spent by the engine (reference 10 in FIG. 1A) at a low power setting prior to a shutdown of the engine 10 (step 302). The tracked time is then correlated with a lookup table (step 304) and it is then assessed from the correlation (step 306) whether pre-shutdown motoring of the engine 10 is to be performed. If it is determined that pre-shutdown motoring of the engine 10 is not to be performed, the motoring duration is set to zero based on the lookup table value(s) (step 308). Otherwise, if it is determined that pre-shutdown motoring is to be performed, the motoring procedure to be executed by the engine 10, i.e. the motoring duration and the motoring speed, is determined using the lookup table (step 310), in the manner described above with reference to FIG. 1B. The next step (312) is then to perform the pre-shutdown motoring procedure.

As shown in FIG. 4, step 312 illustratively comprises automatically initiating motoring of the engine 10 upon receipt of a command to shutdown the engine 10. In particular, step 402 may comprise causing (once the shutdown command is received) the engine 10 to be motored (i.e. run at the low power setting) for the motoring duration (and optionally the motoring speed) determined at step 310. Alternatively, a message may be sent (step 404) to the cockpit to command motoring, the message comprising the motoring duration (and the motoring speed) determined at step 310. If a message is sent to the cockpit to command motoring, the next step 406 is to assess whether the motoring command has been accepted (e.g., by the pilot). If this is not the case, the motoring procedure is aborted at step 408. Otherwise, if it is determined at step 406 that the motoring command has been accepted, the next step 410 is to run the engine at the low power setting for a prescribed motoring duration, prior to engine shutdown. As discussed above with reference to FIG. 1A, in one embodiment, the prescribed duration may be the motoring duration determined at step 310. In another embodiment, the prescribed duration may be a partial motoring duration (e.g., prescribed by the pilot) that is lower than the motoring duration determined at step 310.

The next step 412 (after step 402 or step 410) may then be to assess whether a pilot-initiated abort command or a failure or exceedance of the engine rotation speed sensor(s) (e.g. an EEC-initiated abort event) has occurred. If this is the case, the motoring procedure is aborted (step 408). Otherwise, the next step 414 is to assess whether the motoring procedure has been completed (e.g., the prescribed motoring duration has elapsed). If this is not the case, the method flows back to step 410 to continue the motoring procedure. Otherwise, a message indicating that the motoring procedure is now complete may be output at step 416. Upon completion of the motoring procedure, shutdown of the engine 10 may then be initiated.

In one embodiment, by running (e.g., ground idling) the engine at a low power setting (and accordingly increasing the engine's idle operation time) prior to engine shutdown, the systems and methods described herein may allow to reduce motoring time at engine start. In one embodiment, rotor bow motoring at start-up (i.e. after engine shutdown) may be eliminated, allowing the aircraft to start and take off without delay. In addition, by running (e.g., ground idling) the engine at a low power setting (and accordingly increasing the idle operation time) prior to engine shutdown and accordingly reducing the engine's heat prior to shutdown, the systems and methods described herein may allow to reduce or eliminate the buildup of coke particulates within the engine (e.g., fuel coking in a fuel system of the engine 10 and/or oil coking in an oil system of the engine 10), thereby extending the overall life of engine components and reducing the frequency of engine maintenance events. In other words, the systems and methods described herein may be used to reduce or eliminate coking in a fluid system of the engine.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A method for pre-shutdown motoring of an aircraft engine, the method comprising, at a processing device:
tracking a period of time during which the engine, prior to a shutdown thereof, was operating at a power level below a predetermined threshold;
determining, based on the tracked period of time, a motoring duration for the engine; and
running the engine, prior to the shutdown thereof, at a low power setting for the motoring duration.

2. The method of claim 1, further comprising:
performing a correlation between the tracked period of time and a lookup table, the lookup table providing a value of the motoring duration as a function of the period of time during which the engine was operating at the power level below the predetermined threshold;
assessing, on the basis of the correlation, whether motoring of the engine is to be performed;
responsive to determining that motoring of the engine is to be performed, obtaining the motoring duration from the lookup table, running the engine, prior to the shutdown thereof, at the low power setting for the motoring duration, and initiating the shutdown of the engine once the motoring duration has elapsed; and
aborting responsive to determining that motoring of the engine is not to be performed.

3. The method of claim 1, wherein the engine is ran, prior to the shutdown thereof, at a constant speed for the motoring duration.

4. The method of claim 1, wherein the engine is ran, prior to the shutdown thereof, at an intermittent speed for the motoring duration.

5. The method of claim 1, wherein the engine is ran, prior to the shutdown thereof, at a decreasing speed for the motoring duration in order to bring the engine to a gradual stop.

6. The method of claim 1, wherein the running of the engine, prior to the shutdown thereof, is automatically initiated upon receipt of a command to shutdown the engine.

7. The method of claim 1, wherein the running the engine, prior to the shutdown thereof, comprises sending a motoring command to an aircraft cockpit.

8. The method of claim 7, wherein the engine is ran, prior to the shutdown thereof, for the motoring duration responsive to receiving an indication that the motoring command is accepted.

9. The method of claim 7, further comprising:
receiving an indication that the motoring command is accepted;
receiving a partial motoring duration to be prescribed for the engine, the partial motoring duration lower than the motoring duration as determined;
running the engine, prior to the shutdown thereof, at the low power setting for the partial motoring duration; and
initiating the shutdown of the engine once the partial motoring duration has elapsed.

10. The method of claim 1, wherein the engine is ran, prior to the shutdown thereof, for mitigating bowing of a rotor of the engine.

11. The method of claim 1, wherein engine is ran, prior to the shutdown thereof, for preventing coking in a fluid system of the engine.

12. A system for pre-shutdown motoring of an aircraft engine, the system comprising:
at least one processing unit; and
a non-transitory memory communicatively coupled to the at least one processing unit and comprising computer-readable program instructions executable by the at least one processing unit for:
tracking a period of time during which the engine, prior to a shutdown thereof, was operating at a power level below a predetermined threshold;
determining, based on the tracked period of time, a motoring duration for the engine; and
running the engine, prior to the shutdown thereof, at a low power setting for the motoring duration.

13. The system of claim 12, wherein the instructions are executable by the at least one processing unit for:
performing a correlation between the tracked period of time and a lookup table, the lookup table providing a value of the motoring duration as a function of the period of time during which the engine was operating at the power level below the predetermined threshold;
assessing, on the basis of the correlation, whether motoring of the engine is to be performed;
responsive to determining that motoring of the engine is to be performed, obtaining the motoring duration from the lookup table, running the engine, prior to the shutdown thereof, at the low power setting for the motoring duration, and initiating the shutdown of the engine once the motoring duration has elapsed; and
aborting responsive to determining that motoring of the engine is not to be performed.

14. The system of claim 12, wherein the instructions are executable by the at least one processing unit for running the engine, prior to the shutdown thereof, at one of a constant speed, an intermittent speed, and a decreasing speed for the motoring duration.

15. The system of claim 12, wherein the instructions are executable by the at least one processing unit for running of the engine, prior to the shutdown thereof, comprising automatically initiating the running of the engine upon receipt of a command to shutdown the engine.

16. The system of claim 12, wherein the instructions are executable by the at least one processing unit for running the engine, prior to the shutdown thereof, comprising sending a motoring command to an aircraft cockpit.

17. The method of claim 16, wherein the instructions are executable by the at least one processing unit for running the engine, prior to the shutdown thereof, for the motoring duration responsive to receiving an indication that the motoring command is accepted.

18. The method of claim 16, wherein the instructions are executable by the at least one processing unit for:
receiving an indication that the motoring command is accepted;
receiving a partial motoring duration to be prescribed for the engine, the partial motoring duration lower than the motoring duration as determined;
running the engine, prior to the shutdown thereof, at the low power setting for the partial motoring duration; and
initiating the shutdown of the engine once the partial motoring duration has elapsed.

19. A non-transitory computer readable medium having stored thereon program code executable by at least one processor for:
tracking a period of time during which an aircraft engine, prior to a shutdown thereof, was operating at a power level below a predetermined threshold;
determining, based on the tracked period of time, a motoring duration for the engine; and
running the engine, prior to the shutdown thereof, at a low power setting for the motoring duration.
